(19) United States
(12) Patent Application Publication
(10) Pub. No.: US 2008/0024017 A1
(43) Pub. Date: Jan. 31, 2008

(54) Magnetic energy power machine

(76) Inventor: Yow-Chang Chen, Nantou Hsien (TW)

Correspondence Address: COOPER & DUNHAM, LLP, 1185 AVENUE OF THE AMERICAS, NEW YORK, NY, 10036, US

(21) Appl. No.: 11/496,182

(22) Filed: Jul. 31, 2006

(51) Int. Cl. H02K 33/00; H02K 49/00; H02K 21/00

(52) U.S. Cl. 310/36; 310/103; 310/152

(57) ABSTRACT

A magnetic energy power machine has a base, a power wheel-set and a driving devices pivotally mounted through the base. The power wheel-set has a power shank, which is connected with a follower wheel, and multiple eccentric cams with multiple embedded first permanent magnets are mounted on the power shank. A driving wheel engaged with the follower wheel is mounted on a driving shaft mounted rotatably on the base. The driving shaft has multiple motivate members and each motivate member is embedded with a second permanent magnet. The magnetic energy power machine may further have a brake device to stop the rotating power wheel-set or a clutch device to disengage the follower wheel from the driving wheel therefore to stop the power supply of the magnetic energy power machine. The interaction of the second permanent magnet and the first permanent magnets generates continuous power.

### BACKGROUND OF THE INVENTION

1. Field of the Invention

The present invention relates to a power machine, and particularly relates to a magnetic energy power machine using the magnetic energy stored in permanent magnets.

2. Description of the Related Art

Conventional power machines normally use oil or electric sources. However, in remote area, the electric source or other energy source is limited and can not provide power continuously so it is a big problem for the conventional power machines.

In addition, the conventional energy source will leave polluted air or harmful contaminant, which produces environmental pollution.

Therefore, the invention provides a magnetic energy power machine to mitigate or obviate the aforementioned problems.

### SUMMARY OF THE INVENTION

The main objective of the present invention is to provide a magnetic energy power machine using the magnetic energy stored in first permanent magnets to supply power.

A magnetic energy power machine in accordance with the present invention comprises a base, a power wheel-set and a driving devices pivotally mounted through the base. The power wheel-set has a power shank, which is connected with a follower wheel, and multiple eccentric cams with multiple embedded first permanent magnets are mounted on the power shank. A driving wheel engaged with the follower wheel is mounted on a driving shaft mounted rotatably on the base. The driving shaft has multiple motivate members and each motivate member is embedded with a second permanent magnet. The interaction of the second permanent magnet and the first permanent magnets generates continuous power.

The magnetic energy power machine may further have a brake device to stop the rotating power wheel-set or a clutch device to disengage the follower wheel from the driving wheel therefore to stop the power supply of the magnetic energy power machine.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a magnetic energy power machine in accordance with the present invention;

FIG. 2 is a perspective view of the magnetic energy power machine without the base in FIG. 1;

FIG. 3 is a side view the magnetic energy power machine without the base in FIG. 2;

FIGS. 4-7 are operational side views of the eccentric cam and the motivate member of the magnetic energy power machine in FIG. 3;

FIG. 8 is a perspective view of a second embodiment of a magnetic energy power machine in accordance with the present invention;

FIG. 9 is a perspective view of the magnetic energy power machine without the base in FIG. 8;

FIG. 10 is a side view of the magnetic energy power machine without the base in FIG. 9;

FIG. 11 is a perspective view of a third embodiment of a magnetic energy power machine in accordance with the present invention;

FIG. 12 is a bottom view in partial section of the magnetic energy power machine in FIG. 11;

FIG. 13 is a perspective view of a fourth embodiment of a magnetic energy power machine in accordance with the present invention; and

FIG. 14 is a bottom view in partial section of the fourth embodiment of a magnetic energy power machine in FIG. 13.

### DETAILED DESCRIPTION OF THE PREFERRED EMBODIMENT

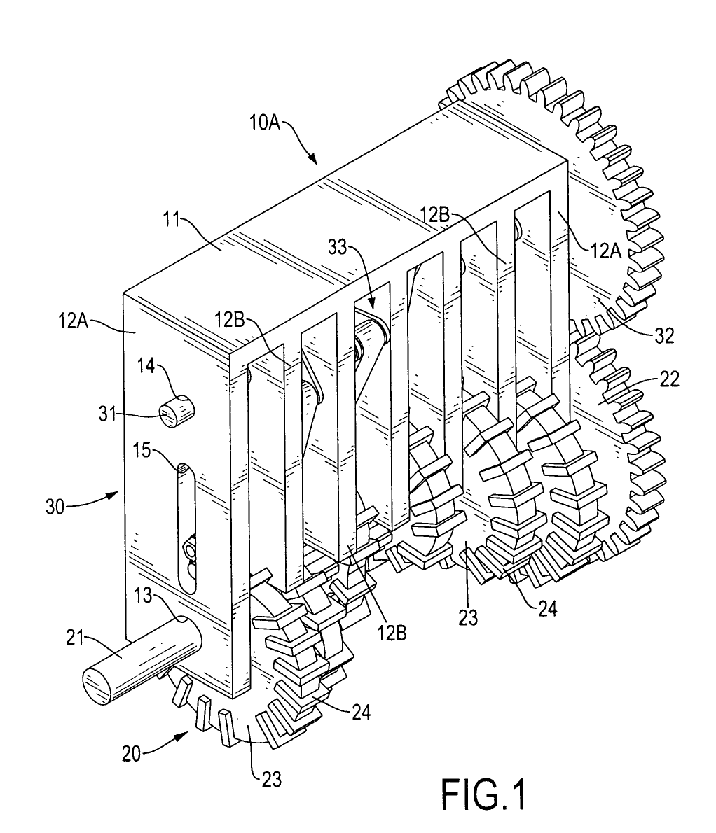

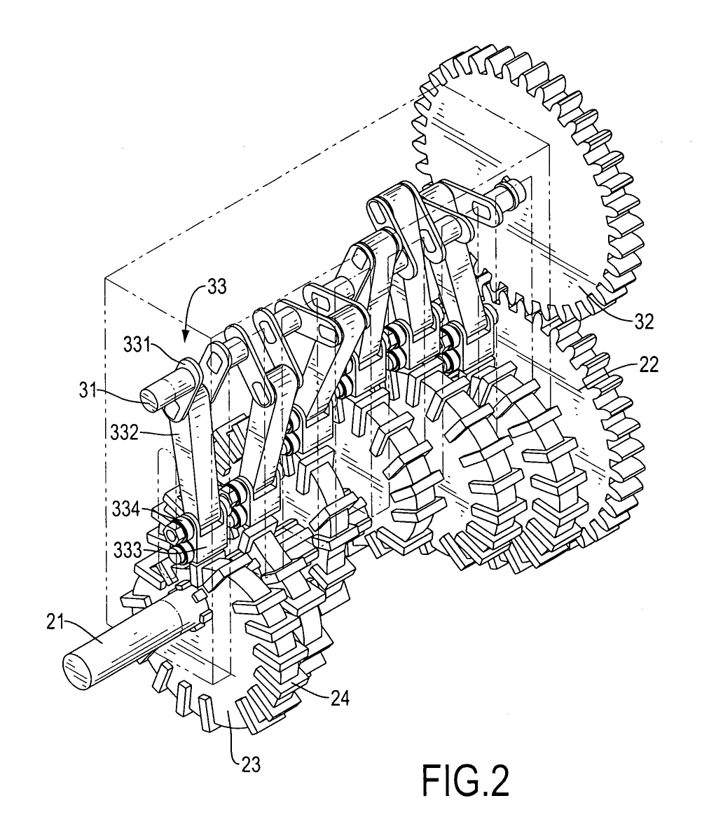

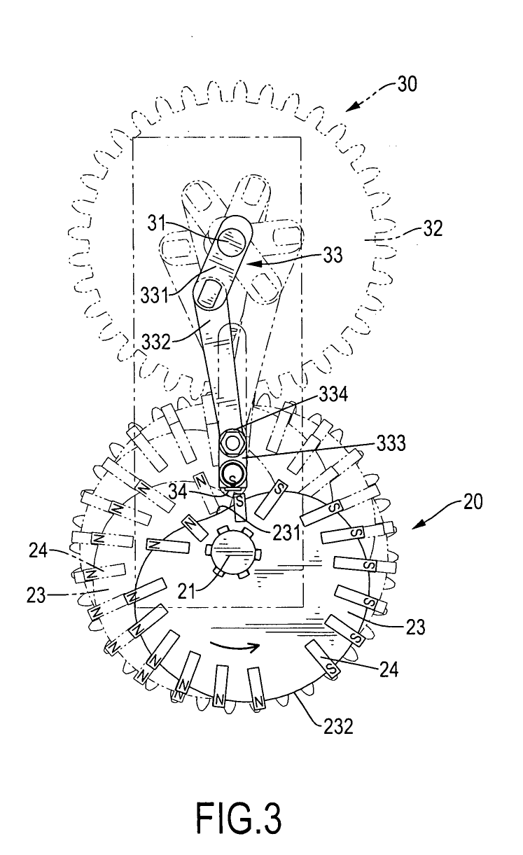

With reference to FIG. 1-3, a first embodiment of a magnetic energy power machine in accordance with the present invention has a base (10A), a power wheel-set (20) rotatably mounted on the base (10A) and a driving device (30) rotatably mounted on the base (10A) and engaged with the wheel-set (20). The base (10A) has a roof (11) being rectangular, and two first clapboards (12A) being rectangular, respectively extending from two short edges of the roof (11). Each first clapboard (12A) has a bottom edge. Five second clapboards (12B) extend from the roof (11) between the two first clapboards (12A). The first and second clapboards (12A, 12B) are spaced at intervals. The five second clapboards (12B) are shorter than the first clapboard (12A).

Each first clapboard (12A) has a shaft hole (13) defined through the first clapboard (12A) near the bottom edge, the power wheel-set (20) is mounted rotatably on the base (10A). Each of the first and second clapboards (12A, 12B) has a driving hole (14) defined therethrough above the shaft holes (13) of the first clapboards (12A), whereby the driving device (30) is mounted rotatably on the base (10A). A guiding slot (15) is defined through a front one of each adjacent two of the first and second clapboards (12A, 12B) above the shaft holes (13) and under the driving holes (14). In other words, each guiding slot (15) is located in front of a corresponding interval between corresponding first and second clapboards (12A, 12B).

The power wheel-set (20) has a power shank (21) mounted rotatably through the shaft hole (13) and having a front end and a rear end. A follower wheel (22) is mounted on the rear end of the power shank (21) and the follower wheel (22) is a round gear. In addition, the power shank (21) is mounted through six eccentric cams (23). The eccentric cams (23) are mounted respectively on the power shank (12) in the intervals between the first and second clapboards (12A, 12B). Each eccentric cam (23) is symmetrical and kidney-shaped and has a symmetrical line, an annular outer edge, a valley (231) and a ridge (232). The annular outer edge is composed of two C-shaped edge halves. The power shank (21) is mounted through the symmetrical line of each eccentric cam (23) close to the valley (231).

The rotational positions of the eccentric cams (23) according to a rotational axis of the power shank (21) are arranged clockwise in turn from the front end to the rear end of the power shank (12), which means a second eccentric cam (23) is turned a certain angle clockwise as compared with a first eccentric cam (23), and a third eccentric cam (23) is turned a certain angle clockwise as compared with the second eccentric cam (23), etc. Two magnet sets are mounted respectively on the edge halves of the annular outer edge of each eccentric cam (23) and each magnet set has multiple first permanent magnets (24). The first permanent magnets (24) of one magnet set are embedded in one edge half of the eccentric cam (23) and each first permanent magnet (24) has a south (S) pole extending outward. The first permanent magnets (24) of the other magnet set is embedded in the other edge half of the eccentric cam (23) and has a north (N) pole extending outward. Inner ends of all the magnets (24) point toward the power shank (21). No first permanent magnets (24) are embedded in the valley (231) and the ridge (232) of each eccentric cam (23), and the valley (231) and the ridge (232) are respectively a lower dead point and a top dead point of a motion of the eccentric cam (23).

The driving device (30) has a driving shaft (31), a driving wheel (32) and multiple motivate members (33).

The driving shaft (31) is rotatably mounted through the driving holes (14) of the first and second clapboards (12A, 12B).

The driving wheel (32) is mounted in the rear end of the driving hole (14) and is a round gear and engaged with the follower wheel (22).

The motivate members (33) are mounted on the driving shaft (31) and are located respectively in the intervals between the first and second clapboards (12A, 12B). The motivate members (33) are mounted on the driving shaft (31) and correspond to the eccentric cams (23). Each motivate member (33) has a crank (331) and an arm (332). The crank (331) is mounted securely on and extends radially from the driving shaft (31). Rotational positions of the cranks (331) according to the rotational axis are different. The arm (332) is connected pivotally to a free end of the crank (331), and a free end of the arm (332) is mounted with a magnet base (333). The magnet base (333) is U-shaped and has a front face and a back face. The front face of the magnet base (333) has two guiding wheels (334) rotatably mounted on the front face and being capable of rolling respectively in a corresponding guiding slot (15). The motion control of the eccentric cam (23) is implemented by rolling the guiding wheel (334) up and down in the guiding slot (15). The bottom of the magnet base (333) has a second permanent magnet (34) embedded in the bottom of the magnet base (333). The driving wheel (32) and the follower wheel (22) turn synchronistically to keep each second permanent magnet (34) from contacting the first permanent magnets (24) of a corresponding eccentric cam (23). The engagement of the driving wheel (32) and the follower wheel (22) always maintains an enough short distance between the second permanent magnet (34) and a first permanent magnet (24) of the corresponding eccentric cam (23) closest to the second permanent magnet (34) to generate a sufficient magnetic force between the second permanent magnet (34) and the closest first permanent magnet (24).

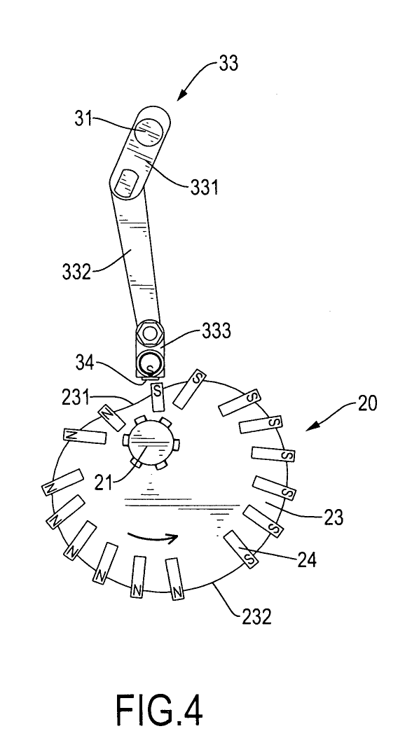

FIGS. 4-7 show the operation of the first embodiment of the present invention. With reference to FIG. 4, the eccentric cam (23) turns counterclockwise from a first rotational position. A corresponding magnet base (333) has the second permanent magnet (34) with an S pole extending outward, and a corresponding first permanent magnet (24) on the eccentric cam (23) has the S pole extending outward to the S pole of the second permanent magnet (34). Therefore, the arm (332) is pushed by the magnet base (333) due to the repulsive force. Furthermore, the crank (331) is driven by the arm (332), and the driving shaft (31) rotates clockwise along with the crank (331). In the other hand, the reverse force to the first permanent magnet (24) points toward the power shank (21) through the eccentric cam (23), so the reverse force will not affect the turning of eccentric cam (23).

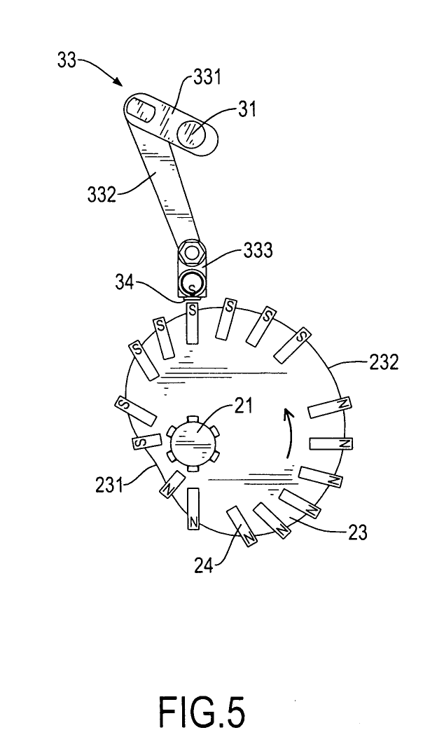

With reference to FIG. 5, when the eccentric cam (23) turns counterclockwise to a second rotational position, a corresponding first permanent magnet (24) still has the S pole extending outward. The repulsive force will further push the arm (332) to move upward, and the crank (331) is further driven by the arm (332). At that time, the crank (331) has been turned for 90 degree from the first rotational position.

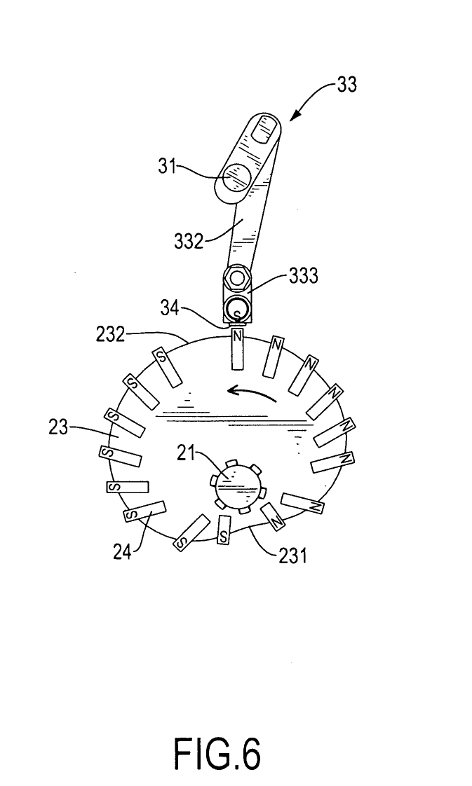

With reference to FIG. 6, when the eccentric cam (23) turns counterclockwise to a third rotational position, a corresponding first permanent magnet (24) has the N pole extending outward, which attracts the magnet base (333). The arm (332) is pulled down by the magnet base (333) due to the attractive force. The crank (331) is further driven by the arm (332) and goes on turning clockwise until an angle of 180 degree from the first rotational position.

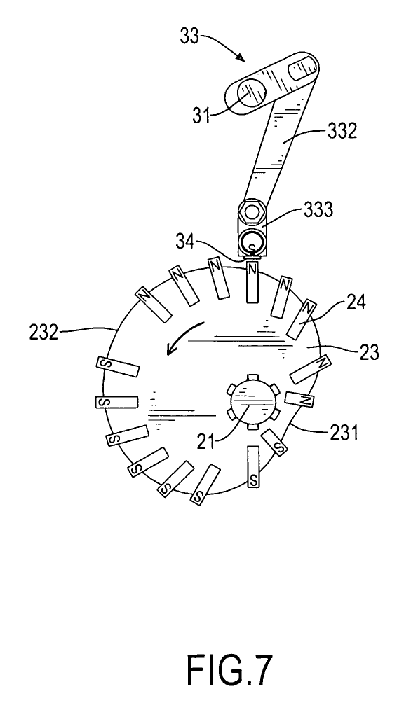

With reference to FIG. 7, when the eccentric cam (23) turns to a fourth rotational position, a corresponding first permanent magnet (24) still has the N pole extending outward, the magnet (333) still pulls the arm (332) downward, so the crank (331) is further driven by the arm and goes on turning clockwise until an angle of 270 degree. The eccentric cam (23) continue turning clockwise to the first rotational position, and finishes a cycle. Then the eccentric cam (23) goes round and round in the same way and the driving shaft (31) is turned continuously by the crank (331), then the driving wheel (32) drives the follower wheel (22), which brings the power shank (21), and again drives the eccentric cams (23). Therefore, a continuous turning can be kept in that way to output power.

The power shank (21) may have a variable number of the eccentric cams (23) and a variable number of the motivate members (33) corresponding to the eccentric cams (23). However, when the lower dead point or the top dead point faces the magnet base (333), even there is a permanent magnet mounted therein, the motivate member (33) can not be activated. Therefore, only one eccentric cam (23) can not activate the motivate member (33), at least two eccentric cam (23) mounted in different rotational positions is necessary in accordance with the present invention. When one of the at least two eccentric cams (23) faces the magnet base (333) with its lower dead point or top dead point, another eccentric cam (23) can still drive the motivate member to provide continuous power.

The number of the eccentric cam (23) can be increased to enhance the continuous power.

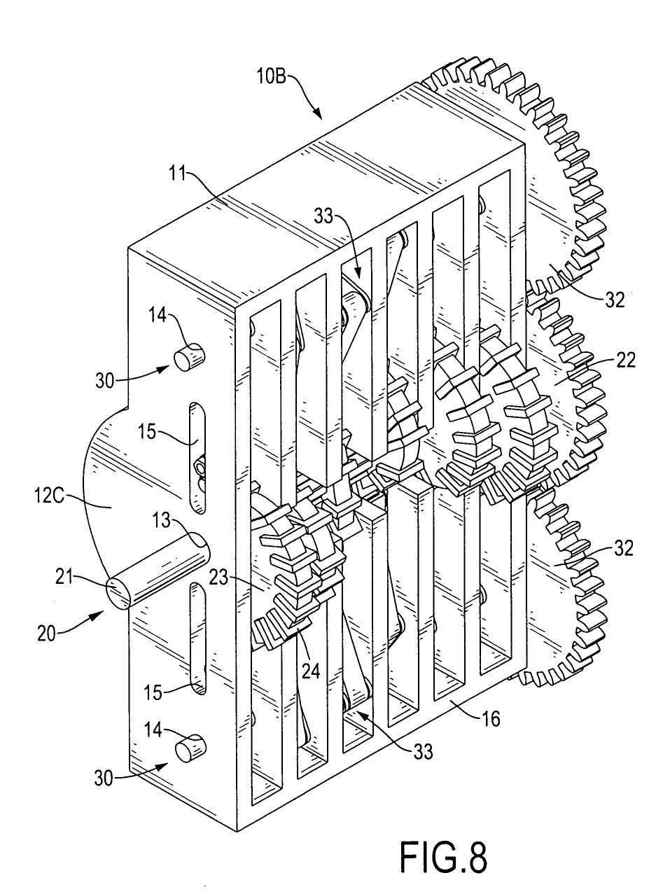

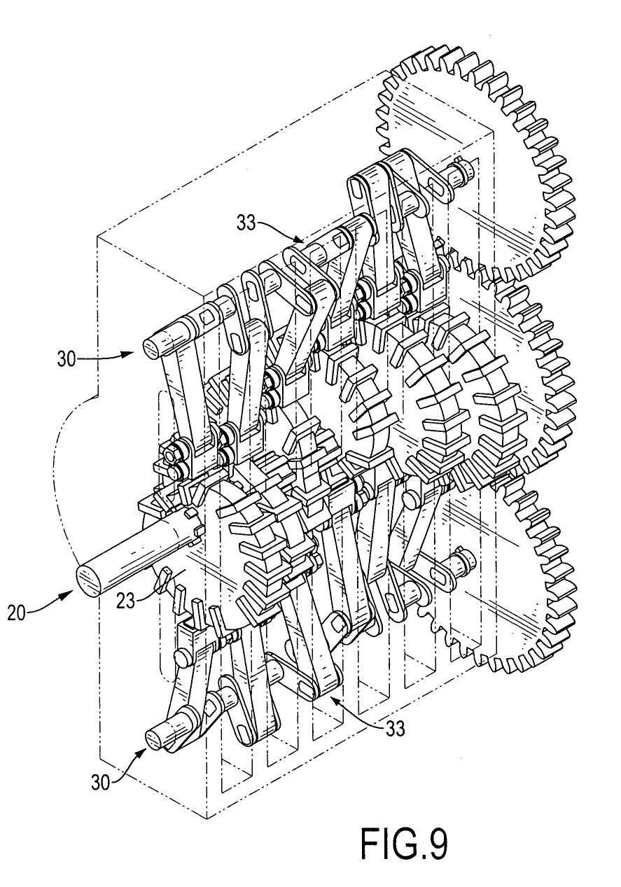

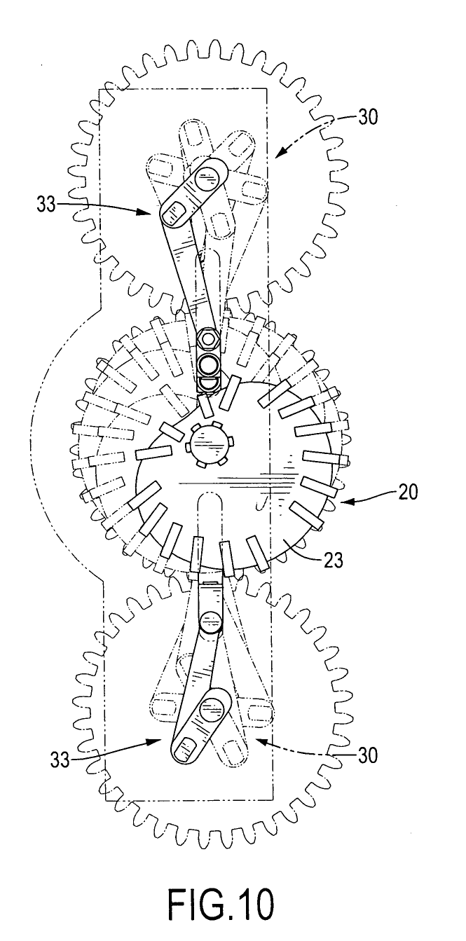

FIGS. 8-10 show a second embodiment of a magnetic energy power machine in accordance with the present invention and further has a second driving device (30) mounted on the magnetic energy power machine. The magnetic energy power machine of the second embodiment has a base (10B), which further includes a roof (11) and a bottom (16). The roof (11) and the bottom (16) are rectangular, two third clapboards (12C) are respectively connected with short edges of the roof (11) and the bottom (16). Five first clapboards (12A) are mounted on the base (10B) between the two third clapboards (12C) and all of the first and third clapboards (12A, 12C) are arranged at intervals.

A shaft hole (13) is defined in a center of each third clapboard (12C). A power wheel-set (20) is mounted rotatably through the shaft hole (13). Two driving holes (14) are defined through each third clapboard (12C) and the two driving holes (14) in each third clapboard (12C) are respectively above and below the shaft hole (13). Two guiding slots (15) are defined through each third clapboard (12C) and each guiding slot (15) is located under the driving holes (14) and above the shaft holes (13), as shown in FIG. 8. The two driving device (30) are mounted between the third clapboards (12C). The operation of the second embodiment is the same as the operation of the first embodiment, so the detailed description of the operation of the second embodiment is omitted.

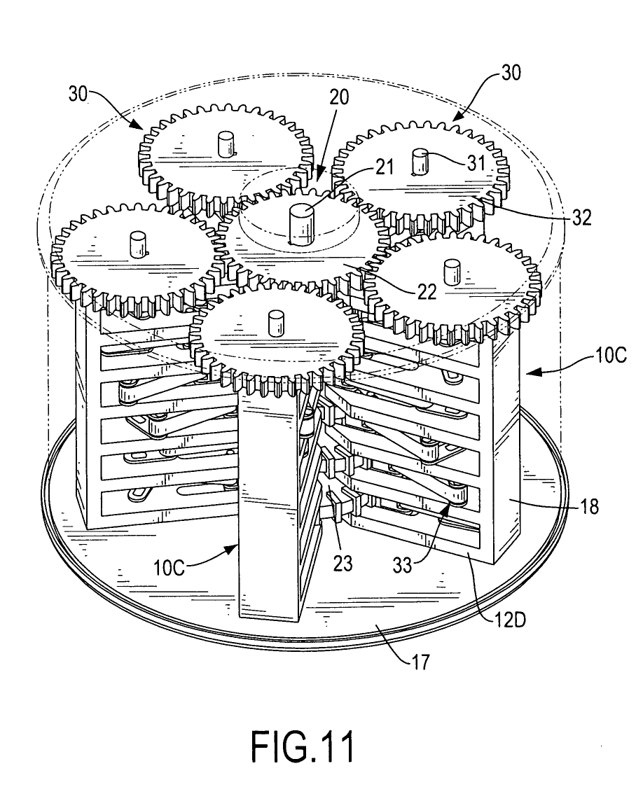

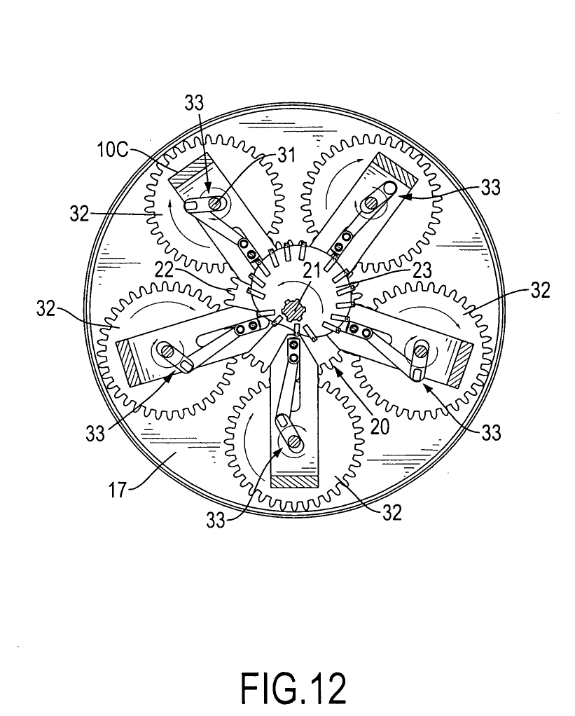

With reference to FIGS. 11-12, a third embodiment of a magnetic energy power machine in accordance with the present invention has a base (17) having a shaft hole defined in a center of the base (17) and a power wheel-set (20) pivotally mounted in the center of the base (17). Five seats (10C) are mounted vertically on the base (17) around the wheel-set (20), and five driving wheels (32) are mounted respectively on the five seats (10C). Each seat (10C) has a standing board (18) and seven fourth clapboards (12D) extending from the standing board (18) and toward the power wheel-set (20). A driving device is mounted pivotally through the fourth clapboards (12D). The follower wheel (22) is mounted on the power wheel-set (20) and is engaged with the driving wheels (32). The operation of the third embodiment is the same as the operation of the first embodiment, so the detailed description of the operation of the third embodiment is omitted.

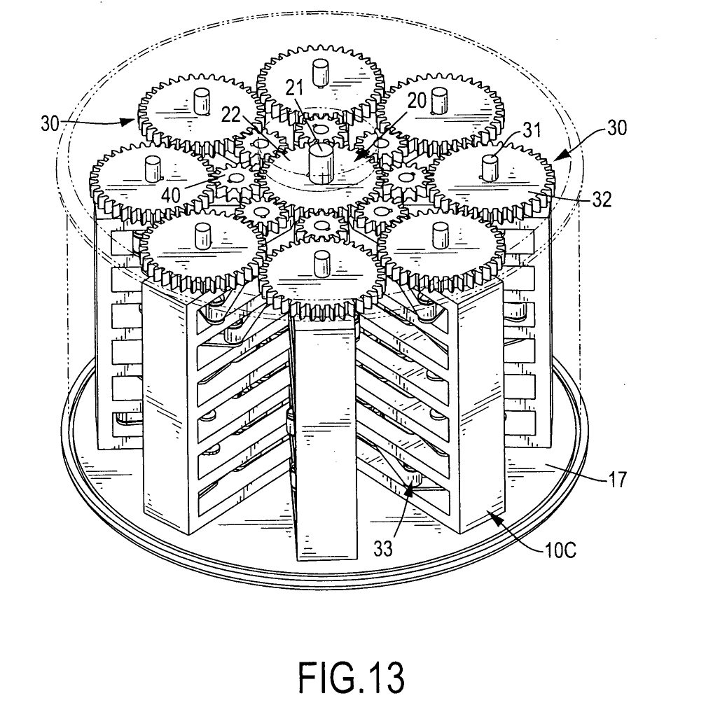

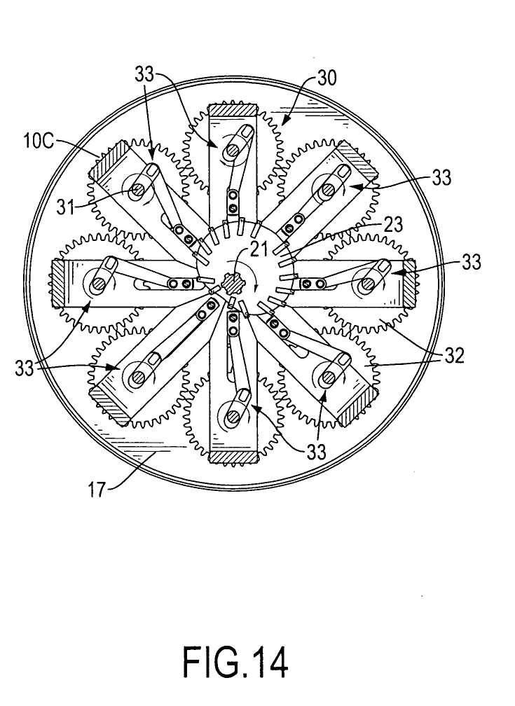

With reference to FIGS. 13-14, a fourth embodiment of a magnetic energy power machine has three more seats (10C) comparing with the third embodiment, so there are eight seats (10C) mounted on the base (17) round the power wheel-set (20). The eight driving wheels (32) can not be engaged with the follower wheel (22), so an idle wheel (40) is rotatably mounted on each seat (17) and is engaged between a corresponding driving wheel (32) and follower wheel (22). The operation of the fourth embodiment is the same as the operation of the first embodiment, so the detailed description of the operation of the fourth embodiment is omitted.

The magnetic energy power machine uses magnet characteristics to drive the crank (331), and the driving wheel (32) further drive the follower wheel (22), which pushes the power shank (21) to turn, further drives the eccentric cams (23). In this way, a continuous power is provided by the repeated operational cycles of the magnetic energy power machine.

It is also possible that the power shank (21) is connected with an electrical generator to provide electric power, without any pollution.

Comparing with the first embodiment, the second, third and fourth embodiments have at least one additional driving device (30), which further improve the turning speed and enhance the output power.

Furthermore, the magnetic energy power machine may further have a brake device to stop the rotating power wheel-set (20) or a clutch device to disengage the follower wheel (22) from the driving wheel (32) therefore to stop the power supply of the magnetic energy power machine.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A magnetic energy power machine comprising a base, a power wheel-set and a first driving device rotatably mounted on the base, wherein:
the base comprises at least one shaft holes defined through the base and through which the power wheel-set is mounted, and multiple first driving holes defined through the base and through which the first driving device is mounted;
the power wheel-set comprises a power shank rotatably mounted through the power hole, and connected with a follower wheel and multiple eccentric cams mounted on the power shank with different rotational positions according to a rotational axis of the power shank, and each eccentric cam having an annular outer edge composed of two edge halves, two magnet sets mounted respectively on the two edge halves of the annular outer edge of each eccentric cam and each magnet set having multiple first permanent magnets, the first permanent magnets of each magnet set embedded in a corresponding edge half of the eccentric cam and each first permanent magnet having a south pole extending outward, and the first permanent magnets of the other magnet embedded in the other edge half of the each eccentric cam and each first permanent magnet having a north pole extending outward;
the first driving device comprises a first driving shaft mounted through the first driving holes and connected with a driving wheel connected with the follower wheel, multiple motivate members mounted on the first driving shaft corresponding to the eccentric cams and each motivate member having a crank mounted securely on and extending from the first driving shaft and an arm pivotally connected to the crank a free end of the arm mounted with a magnet base mounted with a second permanent magnet embedded in the magnet base and a magnetic force generated between the second permanent magnet and a first permanent magnet of a corresponding eccentric cam closest to the second permanent magnet.

2. The magnetic energy power machine as claimed in claim 1, wherein:
the base comprises at least three clapboards arranged at intervals, the first driving holes are defined respectively through the at least three clapboards, a first guiding slot is defined through a front one of each adjacent two of the at least three clapboards and the first guiding slots are located respectively in front of the intervals, a number of the at least one power hole is two and the two power holes are defined respectively through two of the at least three clapboards, the power shank is mounted through the shaft holes in corresponding clapboards, the first driving shaft is mounted through the first driving holes in the at least three clapboards;
the eccentric cams are located respectively in the intervals and the motivate members are located respectively in the intervals; and
the magnet base of each motivate member has two guiding wheel rotatably mounted on the base and capable of rolling in the first guiding slot in a corresponding clapboard.

3. The magnetic energy power machine as claimed in claim 2, wherein a number of the clapboards on the base are seven clapboards, and a number of the eccentric cams are six.

4. The magnetic energy power machine as claimed in claim 2, wherein:
the base further has multiple second driving holes respectively defined through the at least three clapboards;
a second driving device is mounted rotatably on the base and comprises
a second driving shaft mounted through the second driving holes and connected with a driving wheel engaged with the follower wheel; and
multiple motivate members mounted on the second driving shaft corresponding to the eccentric cams and each motivate member having a crank mounted securely on and extending from the second driving shaft and an arm pivotally connected to the crank a free end of the arm mounted with a magnet base mounted with a second permanent magnet embedded in the magnet base and a magnetic force generated between the second permanent magnet and a first permanent magnet of a corresponding eccentric cam closest to the second permanent magnet.
